(19) United States
(12) Patent Application Publication
(10) Pub. No.: US 2005/0076040 A1
(43) Pub. Date: Apr. 7, 2005

(54) Communications system version processing

(76) Inventors: Timothy J. Sherburne, Carol Stream, IL (US); Ibrahima Niass, Chicago, IL (US)

Correspondence Address: MOTOROLA, INC., 1303 EAST ALGONQUIN ROAD, IL01/3RD, SCHAUMBURG, IL, 60196, US

(21) Appl. No.: 10/677,885

(22) Filed: Oct. 2, 2003

(51) Int. Cl. G06F 7/00

(52) U.S. Cl. 707/100

(57) ABSTRACT

A method, and apparatus for, providing a system version, associated with a communications system, for example a cellular communications system (1), wherein there are a plurality of different system versions, for example different system configurations, represented by nodes (31-34) in a genealogy tree (30) with respective change logs (36, 38, 40) defining changes made between system versions of linked nodes, the method comprising: selecting a system version to be provided; selecting a storage space, for example in a database (28); determining a path through the genealogy tree (30) from a node of the tree previously associated with the selected storage space to the node of the system version selected to be provided; and applying those operation change logs present on the determined path through the genealogy tree (30), thereby providing the selected system version. The method and apparatus may be implemented in an operations and maintenance centre (OMC) (16).

### FIELD OF THE INVENTION

The present invention relates to communications system version processing. The present invention relates in particular, but not exclusively, to processing information stored in a database and relating to different system versions where the system versions specify details of the communications system, for example a configuration specification. The communications system may be a cellular communications system, including for example Universal Mobile Telecommunications System (UMTS), General Packet Radio Service (GPRS) and Global System for Mobile Telecommunication (GSM) systems.

### BACKGROUND OF THE INVENTION

The system configuration of a cellular communications system comprises information and specifications such as which elements (e.g. mobile services switching stations, base stations, and so on) are included in the system, along with defining connections between these elements. Typically, the system configuration also includes cell configuration details, such as neighbour lists, and frequency plans specifying the frequencies at which radio communication takes place between the base stations and subscriber/user equipment such as mobile telephones. Generally, the system configuration may include many other operating parameters.

A communications system, especially a cellular communications system, typically undergoes frequent changes to its system configuration. Usually, multiple system-wide versions of a system configuration, (which may conveniently be termed “system versions”) are maintained by the operator of the system (and/or any other parties responsible for operational and managerial control of the system). Furthermore, new system versions are planned, tested and implemented.

A known mechanism for operators to manage multiple system-wide versions of a system (network) configuration is to use a genealogy tree. The genealogy tree comprises nodes, each node defining a respective system version, and connections between the nodes. Each connection has data associated with it, called an operator change log, specifying the changes made to its first system version node to arrive at its second system version node. Change logs are well known, and are conventionally used, as the name suggests, for tracking historical changes, i.e. change logs are conventionally used for retrospective analysis.

Typically, system operators require the ability to plan system-wide configuration changes in an “offline” system version in order to:
(i) bundle together a large set of planned changes (e.g. frequency re-tunes, neighbour cell updates, migrating a set of sites between base stations, and so on);
(ii) validate the complete set of changes; and
(iii) deploy the set of changes into the system as a coordinated unit of work.

Conventionally, each system version represented in the genealogy tree is implemented as a complete database copy. When a system operator seeks to create a new system version, it is necessary to copy the complete database copy of the system version the operator wishes to adapt. This can take a significant amount of time (e.g. tens of minutes), which is inconvenient and inefficient. As communications systems, especially cellular communications systems, become ever larger and ever more complex, this becomes increasingly disadvantageous.

### SUMMARY OF THE INVENTION

In a first aspect, the present invention provides a method of providing a system version associated with a communications system, as claimed in claim 1.

In a further aspect, the present invention provides a storage medium storing processor-implementable instructions, as claimed in claim 7.

In a further aspect, the present invention provides apparatus for providing a system version associated with a communications system, as claimed in claim 8.

In a further aspect of the present invention, a fixed number of database copies are maintained and these are migrated between system versions by replay of the operator change log.

The present invention tends to alleviate or remove the burden of copying complete copies of database copies of system versions, in particular when implementing future changes and actions on the system (as opposed to, say, merely retrospectively analysing previous changes). The present invention tends to provide, or recall, system versions in a quicker and more efficient manner than that provided by copying the complete copy. Potentially, this may be achieved whilst maintaining some or all of the capabilities and advantages of the system version genealogy tree.

### BRIEF DESCRIPTION OF THE DRAWINGS

Embodiments of the present invention will now be described, by way of example only, with reference to the accompanying drawings, in which:

FIG. 1 is a schematic illustration of a cellular communications system;

FIG. 2 is a schematic illustration of certain functional modules of an operations and maintenance centre forming part of the cellular communications system of FIG. 1;

FIG. 3 is a schematic illustration of a system version genealogy tree of the cellular communications system of FIG. 1;

FIG. 4 is a schematic illustration of a system version state change model;

FIG. 5 is a flowchart showing certain process steps involved in a method of providing (or retrieving) system version data.

### DESCRIPTION OF PREFERRED EMBODIMENTS

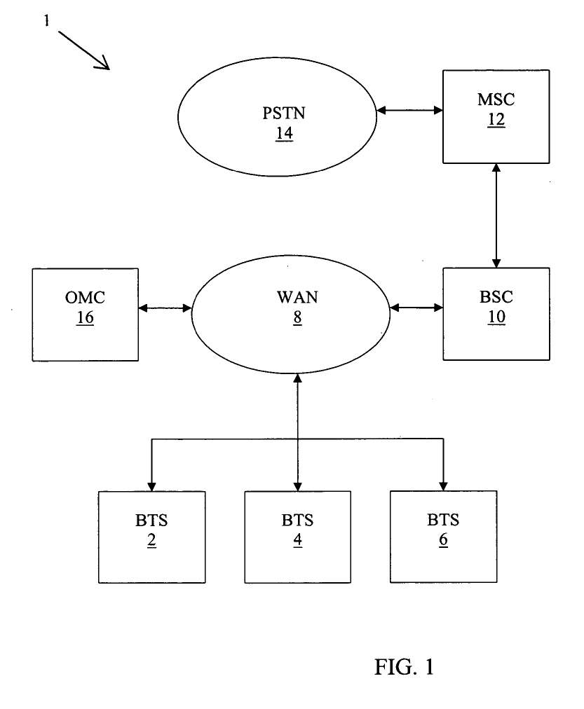

FIG. 1 is a schematic illustration of a cellular communication system 1 (also referred to as network). In this embodiment, the cellular communications system 1 is a Global System for Mobile Telecommunication (GSM) system.

The cellular communications system 1 comprises a large number of base transceiver stations (BTSs). For clarity, only three such BTSs, namely BTSs 2, 4, 6 are shown in FIG. 1. Each BTS 2, 4, 6 provides radio communication service over a respective geographical area, known as a cell, of the overall geographical area served by the cellular communications system 1. The radio communication service is provided in the form of time and frequency multiplexed communication with a large number of subscriber units (not shown), predominantly mobile telephones.

The cellular communications system 1 further comprises a wide area network (WAN) 8, base station controllers (BSCs) and a mobile services switching centre (MSC) 12. For clarity, only one BSC, namely BSC 10, is shown in FIG. 1. The WAN 8 is coupled to the BTSs 2, 4, 6 and the BSC 10. The BSC 10 is coupled to the MSC 12. The BSC 10 performs control functions on the BTSs 2, 4, 6. The required coupling for this is provided via the WAN 8. Connection from the BSC 10 (and other BSCs not shown) to callers and connections external to the cellular communications system is made via MSC 12, which is coupled to PSTN 14 for this purpose.

The cellular communications system 1 further comprises an operations and maintenance centre (OMC) 16. The OMC 16 performs configuration management, performance management and fault management of the cellular communications system 1. The OMC 16 is coupled to the WAN 8, through which it sends instructions to, and receives data from, the other elements of the cellular communications system 1. Furthermore, the OMC 16 specifies and controls aspects of the WAN 8 itself.

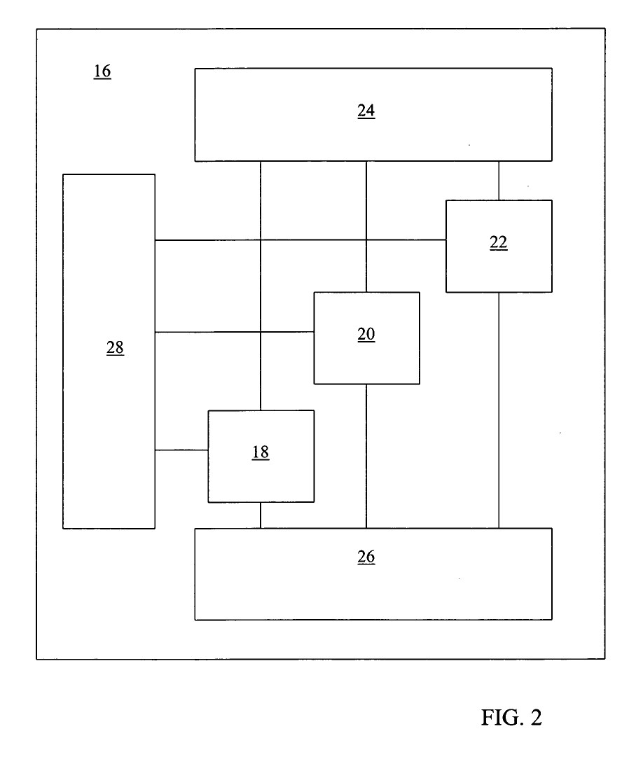

Further details of the OMC 16 will now be described with reference to FIG. 2. FIG. 2 is a schematic illustration of certain functional modules of the OMC 16. The OMC 16 can be considered as comprising a configuration management module 18, a performance management module 20, a fault management system 22, a graphical user interface (GUI) 24, a network element interface (26), and a database 28. The configuration management module 18, the performance management module 20, and the fault management system 22 are each coupled to the GUI 24, the network element interface 26 and the database 28.

The configuration management module 18, using, as required, data stored in the database 28, implements and controls the system configuration, and corresponding system versions, of the cellular communications system 1, these being as described in the introductory part of this description above.

The performance management module 20, using, as required, data stored in the database 28, performs ongoing performance management of the cellular communications system, in particular in ways that do not constitute changes to the system configuration. The fault management module 22, using, as required, data stored in the database 28, reacts to faults that occur in the system 1.

The operator of the cellular communications system 1 provides user input using the GUI 24. For example, if a new system version is to be input, this is done via the GUI 24.

The network element interface 26 outputs instructions and data, provided by the configuration, performance and fault management modules 18, 20 and 22, from the OMC 16 to the WAN 8 for onward transmission to the various elements of the cellular communications system 1. The network element interface 26 also receives data and requests, directed to the configuration, performance and fault management modules 18, 20 and 22 from those elements via the WAN 8.

The cellular communications system 1, as described above, corresponds to a conventional GSM system, and operates in conventional manner, except that the configuration management module 18 of the OMC 16 has been adapted to offer, and provide for, a different way of providing or retrieving system version data, as will be described in more detail below.

This adaptation may be implemented in any suitable manner. A new module may be added to a conventional OMC. The module may consist of a single discrete entity added to a conventional OMC, or may alternatively be formed by adapting existing parts of a conventional OMC, for example by reprogramming of one or more processors therein. As such the required adaptation may be implemented in the form of processor-implementable instructions stored on a storage medium, such as a floppy disk, hard disk, PROM, RAM or any combination of these or other storage media.

Furthermore, whether a separate entity or an adaptation of existing parts or a combination of these, the module may be implemented in the form of hardware, firmware, software, or any combination of these.

It is also within the contemplation of the invention that such adaptation of the means for providing or retrieving system version data may alternatively be controlled, implemented in full, or implemented in part, by a module added to or formed by adaptation of any other suitable part of the cellular communications system 1. For example, if the cellular communications system 1 comprises plural OMCs, then the adaptation may be implemented at some or all of these OMCs. Further, in the case of other system infrastructures or layouts, implementation may be at any appropriate system node where it is possible to implement operations and management functionality. Alternatively, various parts of the process and means for providing or retrieving system version data can be carried out by various elements distributed at different locations or entities within the above described cellular communications system 1 or any other suitable cellular communications network or system.

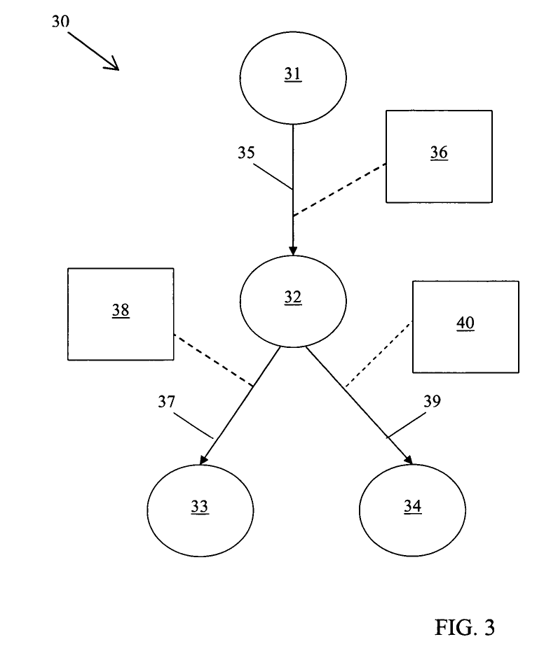

The way in which, in this embodiment, the OMC 16 provides or retrieves system version data will now be described, with reference to FIGS. 3, 4 and 5.

FIG. 3 is a schematic illustration of a system version genealogy tree 30 of the cellular communications system 1, as stored in the database 28 and used by the configuration module 18. The system version genealogy tree 30 represents a graphical view of data stored in the database 28. The genealogy tree 30 comprises nodes representing respective system versions. Usually there will be a very large number of system versions as the configuration of a cellular communications system is altered over time. However, for clarity, this embodiment will be described in a simplified manner in which there are only four system versions (i.e. four nodes), namely a first system version 31, a second system version 32, a third system version 33 and a fourth system version 34.

The genealogy tree 30 further comprises links between the nodes. The links are directional and record which previous system version any given system version was produced from by changes made to that previous system version. Furthermore, the genealogy tree comprises a respective operator change log associated with each link. The change log records the changes made to the previous system version. The previous system version may be termed a parent node, the given system version may be termed a child node in terms of the relationship between those two nodes/system versions.

In this simplified example, the first system version 31 was produced in isolation, i.e. determined from scratch. Therefore there is no link going into the first system version 31, and no associated operator change log. The second system version 32 was provided by changes made to the first system version 31, hence there is a link 35 from the first system version 31 to the second system version 32, and moreover there is an operator change 36 associated with the link 35. The third system version 33 was provided by changes made to the second system version 32, hence there is a link 37 from the second system version 32 to the third system version 33, and moreover there is an operator change 38 associated with the link 37. The fourth system version 34 was also provided by changes made to the second system version 32, hence there is a link 39 from the second system version 32 to the fourth system version 34, and moreover there is an operator change 40 associated with the link 39.

It is noted that the system version currently specifying the actual physical configuration of the cellular communications system 1 need not be the last one to be formed. For example, in this simplified example, if the fourth system version 34 was the last one to be formulated, a different system version, for example the third system version 33, may be the system version currently specifying the actual physical configuration of the cellular communications system 1.

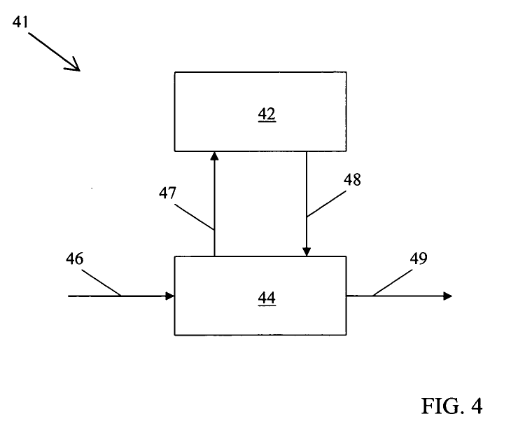

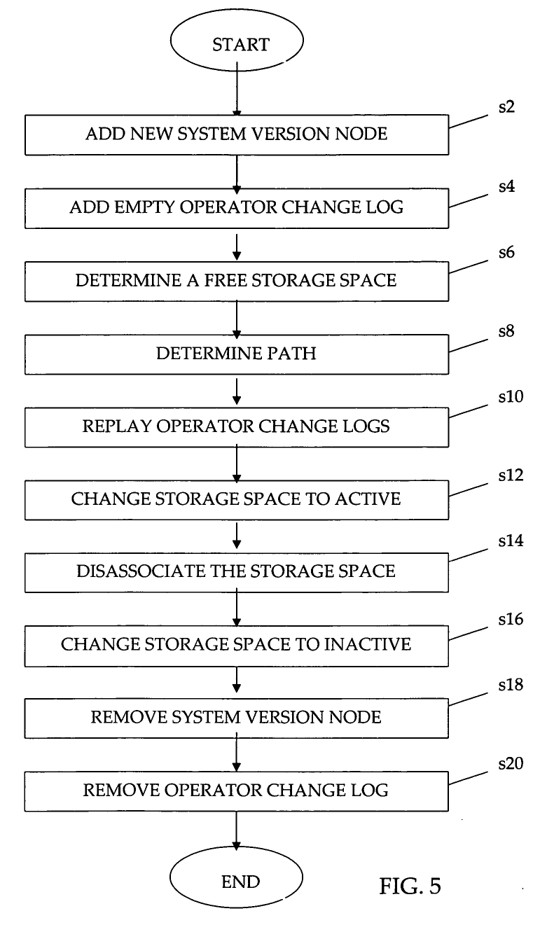

In this embodiment, a further question of status of the different system versions is employed (i.e. in addition to, and different to, the question of which system version currently specifies the actual physical configuration of the cellular communications system 1). This further question of status is that only a given limited number of system versions are set in an “active” state rather than an “inactive” state. Here, the “active” state means, broadly speaking, that the details of an “active” system version are relatively readily accessible and available for use by the operator of the cellular communications system 1, for example for performing a simulation exercise, whereas those of an “inactive” system version are not. This concept will be described in more detail below with reference to FIGS. 4 and 5, but is mentioned here so that the this question of whether a particular system version is “active” as opposed to “inactive” is not later confused with the question of whether a system version is the system version currently specifying the actual physical configuration of the cellular communications system 1.

FIG. 4 is a schematic illustration of a system version state change model 41, graphically representing state transitions between the states of “active” and “inactive” for a given system version. The state change model 41 comprises two states, namely an active state 42 and an inactive state 44. The state change model 41 further comprises state transitions represented by arrows. In particular, the state change model 41 comprises a “create system version” state transition 46 directed in to the inactive state 44, a “select system version” state transition 47 from the inactive state 44 to the active state 42, a “deselect system version” state transition 48 from the active state 42 to the inactive state 44, and a “delete system version” state transition directed away from the inactive state 44.

Further details of the active state 42 and the inactive state 44 are as follows. In the case of the active state 42, the system version is selected by the operator (or in the case of plural operators, one or more operators). In this case, storage space in the database 28 is associated with the system version. An active system version allows operators to readily access or retrieve data specifying the system version, thereby allowing this to be used as required, for example to (i) query and generate reports about the system version, or (ii) update and validate proposed or contemplated changes across the system version, e.g. effect a simulation or other assessment.

In the case of the inactive state 44, the system version is not selected by the operator (or in the case of plural operators, is not selected by any of the operators). In this case, storage space in the database 28 is not associated with the system version. Therefore, an inactive system version does not allow operators to readily access or retrieve data specifying the system version. However, this disadvantage is compensated for by the requirement for less data to be stored, and also by the fact that the inactive state 44 can be relatively efficiently changed to an active state 42 as will be described below.

The way in which the state transitions 46-49 are implemented in this embodiment will now be described in more detail with reference to FIG. 5, which is a flowchart showing certain process steps involved in a method of providing (or retrieving) system version data according to this embodiment.

By virtue of steps s2 and s4, the system version is created. In terms of FIG. 4, this corresponds to the “create system version” state transition 46 being implemented, thereby providing the inactive state 44. Considering steps s2 and s4 individually, at step s2 a new system version node is added to the system version genealogy tree 30. At step s4, an empty operator change log for the new system version is added. The operator change log is empty because at this stage the new system version node is the same as the previous system version node to which it is linked as a “child”, the previous system version node acting as “parent”.

By virtue of steps s6, s8, s10 and s12, the system version is selected, such that storage space in the database 28 becomes associated with the system version. In terms of FIG. 4, this corresponds to the “select system version” state transition 47 being implemented, thereby transitioning to the active state 42.

Considering steps s6, s8, s10 and s12 individually, at step s6 the adapted configuration management module 18 of OMC 16 determines or finds a free storage space in the database 28. The adapted configuration management module 18 is programmed to support a maximum of N (2 in this example) system spaces. If a free system space does not exist, the operator is informed of this via the GUI 24 and the operation will be aborted. The operator can then, if desired, free a database storage space by deactivating one of the currently active system versions.

At step s8, the adapted configuration management module 18 determines the path through the genealogy tree (30) from the system version node where the free database storage space was previously selected to the system version node corresponding to the system version that the operator has now selected. The adapted configuration management module 18 does this by storing the genealogy tree data structure within the database and using standard tree traversal algorithms to determine the path.

At step s10, the adapted configuration management module 18 replays the operator change logs, defined by the path through the genealogy tree 30 determined at step s8, into the free database storage space. That is, the adapted configuration management module 18 applies change actions, recorded in the change logs, to the newly created system version. The change actions may include database record ‘inserts’, ‘updates’ or ‘deletes’. When traversing from a child to parent node in the genealogy tree 30, the operator change log is replayed in reverse order with reverse operation, i.e. add becomes delete, delete becomes add.

At step s12, the database storage space state is changed to active.

The time taken to implement steps s6, s8, s10 and s12 is roughly proportional to the size of the operator change log(s) involved, and may be as short as a few seconds, which is significantly shorter than the tens of minutes which may be required for the conventional method of copying the complete database copy of a system version.

On completion of step s12, the data retrieval and provision is achieved. For completeness, further steps will now be described, which implement optional freeing up of the arrangement to enable further system versions to be easily provided or retrieved.

By virtue of steps s14 and s16, the system version is deselected, such that the storage space in database 28 is again disassociated from the system version. In terms of FIG. 4, this corresponds to the “deselect system version” state transition 48 being implemented, thereby transitioning back to the inactive state 44.

Considering steps s14 and s16 individually, at step s14 the database storage space is disassociated from the system version. The storage space is thus free for association with a different system version at some future point in time. At step s16, the database storage space state is changed to inactive.

On completion of step s16, the storage space required in the database for an activated system version is freed up, but the system version is still available to be provided again by repeating steps s6 to s12 if desired. However, if the system version is completely finished with, then further optional steps s18 and s20, described in the following paragraph, may be implemented, allowing the system version to be deleted, i.e. removed from the genealogy tree 30.

By virtue of steps s18 and s20, the system version is deleted. In terms of FIG. 4, this corresponds to the “delete system version” state transition 49 being implemented, thereby providing the inactive state 44. Considering steps s18 and s20 individually, at step s18 the system version node is removed from the system version genealogy tree 30. At step s20, the operator change log associated with the system version is removed. The possibility of being able to remove the system version in the manner of step s18, i.e. by deleting the system version record (node), is another potential advantage offered, in that this is much simpler than prior art arrangements in which a full database copy is required to be deleted.

Thus, in this embodiment, a complete copy of the database for each system version represented in the genealogy tree need not be maintained. Instead, a fixed number of database copies are maintained and these are migrated between system versions by replay of the operator change log.

In the above embodiment, a database is used for storing the system version data. In other embodiments a plurality of databases may be used. In other embodiments, the data may be stored in forms or locations other than a database as such.

In the above embodiment, the communications system is a GSM cellular communications system. In other embodiments other types of cellular communications systems may be employed. In other embodiments, communications systems other than cellular communications systems may be employed.

In the above embodiment, the system versions are different versions of data defining the communications system configuration. In the case of a cellular communications system of the type described in the above embodiment, the configuration includes variables such as network element connections and relations, operating parameters, neighbour lists, frequency plans, and so on. The present invention is applicable irrespective of which particular variables are included in the configuration. The present invention is also applicable to system versions relating to only part of a configuration, in terms of only some of the variables and/or some of the geographical coverage or some of the elements of the system. Furthermore, in other embodiments, the system versions may be different versions of types of data other than data considered to be configuration data as such.

In the above embodiment, the four following state transitions are included in the overall process described: “create system version” state transition (steps s2 and s4), “select system version” state transition (steps s6, s8, s10 and s12), “deselect system version” state transition (s14 and s16), and “delete system version” state transition (steps s18 and s20). This extends exploitation of potential advantages arising from the present invention. However, the present invention is still of potential benefit when applied in a simpler form. In particular, in other embodiments, only steps corresponding to steps s6 (path determination) and s8 (replaying operator log(s)) may be implemented, and other steps may be omitted or replaced by other process steps that provide suitable setting for implementing steps along the lines of steps s6 and s8.

In the above embodiment, a single operator provides the inputs to process the system versions as described. However, in other embodiments, plural operators may make separate inputs along the lines described above.

1. A method of providing a system version associated with a communications system, wherein there is a plurality of different system versions, specifying data relating to the communications system, associated with the communications system, the system versions being represented by nodes in a genealogy tree with respective change logs defining changes made between system versions of linked nodes, the method comprising:
selecting a system version to be provided;
selecting a storage space;
determining a path through the genealogy tree from a node of the tree previously associated with the selected storage space to the node of the system version selected to be provided; and
applying, to the system version corresponding to the node previously associated with the selected storage space, those operation change logs present on the determined path through the genealogy tree, thereby providing the selected system version:

2. A method according to claim 1, wherein as part of the step of selecting a storage space, an active system version is deactivated, thereby freeing the selected storage space.

3. A method according to claim 1, further comprising deactivating the elected storage space corresponding to the provided system version.

4. A method according to claim 1 wherein the storage space is in a database.

5. A method according to claim 1, wherein the communications system is a cellular communications system.

6. A method according to claim 1, wherein the system versions define system configurations of the communications system.

7. A storage medium storing processor-implementable instructions for controlling a processor to carry out the method of claim 1.

8. Apparatus for providing a system version associated with a communications system, wherein there is a plurality of different system versions, specifying data relating to the communications system, associated with the communications system, the system versions being represented by nodes in a genealogy tree with respective change logs defining changes made between system versions of linked nodes, the apparatus comprising:
means for selecting a system version to be provided;
means for selecting a storage space;
means for determining a path through the genealogy tree from a node of the tree previously associated with the selected storage space to the node of the system version selected to be provided; and
means for applying, to the system version corresponding to the node previously associated with the selected storage space, those operation change logs present on the determined path through the genealogy tree, thereby providing the selected system version.

9. Apparatus according to claim 8, wherein the means for selecting a storage space comprises means for deactivating an active system version to free the selected storage space.

10. Apparatus according to claim 8, further comprising means for deactivating the elected storage space corresponding to the provided system version.

11. Apparatus according to claim 8, further comprising a database, the database being the where the storage space is located.

12. Apparatus according to claim 8, adapted for use in a cellular communications system.

13. Apparatus according to claim 8, wherein the system versions define system configurations of the communications system.

14. An operations and maintenance centre comprising apparatus according to claim 8.
